(19) United States
(12) Patent Application Publication
(10) Pub. No.: US 2012/0262472 A1
(43) Pub. Date: Oct. 18, 2012

(54) HEATMAP TIMELINE FOR VISUALIZATION OF TIME SERIES DATA

(75) Inventors: Matthew Evan Garr, Palo Alto, CA (US); Jiri Rojicek, Prague (CZ); Jiri Vass, Prague (CZ)

(73) Assignee: HONEYWELL INTERNATIONAL INC., Morristown, NJ (US)

(21) Appl. No.: 13/086,255

(22) Filed: Apr. 13, 2011

(51) Int. Cl. G06T 11/00; G06T 11/20

(52) U.S. Cl. 345/589; 345/441

(57) ABSTRACT

An approach for visualization of time series data. The approach for conveying time-series data may be a “heatmap timeline”. Rather than use a spatial dimension indicate a datum value for each timestamp, the heatmap timeline may employ hue, saturation, or value of color, and/or pattern and/or shading, perhaps shown within a geometric shape, to indicate the datum value along a timeline. Data values may be aggregated into one value indication. A tooltip may be pointed to a specific place on of the heatmap timeline to obtain a precise datum value at that place. More than one heatmap timeline may be on a display. Traditional line plots synchronized to the timeline may be added to the same display for comparison purposes. The heatmap timelines of various items within a hierarchical structure may be presented on a display. Data may also be presented in a mosaic fashion.

### BACKGROUND

The present disclosure pertains to presentation of information, and particularly to presentation of data. More particularly, the disclosure pertains to visualization of data.

### SUMMARY

The disclosure reveals an approach for visualization of time series data. The approach for conveying time-series data, whether ordinal, nominal, interval, or ratio, may be a “heatmap timeline”. Rather than use a spatial dimension indicate a datum value for each timestamp, the heatmap timeline may employ hue, saturation, or value of color, and/or pattern and/or shading, perhaps shown within a geometric shape, to indicate the datum value along a timeline. Specific values may be aggregated into one value indication for a certain portion of the timeline period. However, a tooltip may be pointed to a specific place on of the heatmap timeline to obtain a precise datum value at that place. More than one heatmap may be presented relative to one timeline in a display. Traditional line plots synchronized to the timeline may also be presented on the same display for comparison purposes. The heatmap timelines of various items of a hierarchical structure may be presented on a display. Items of the hierarchical structure may have markers allowing the items to be expanded to show heatmaps of components of the items. Information may be presented in a mosaic fashion with, for example, rows of blocks along a timeline. Each row may represent an item. Each block may have one of various colors indicating, for instance, a status of an item of the row with the respective block.

### BRIEF DESCRIPTION OF THE DRAWING

FIG. 1 is a diagram of a graph displaying a heatmap timeline for time series data;

FIG. 2 is a diagram of a mosaic plot revealing an operations summary;

FIG. 3 is a diagram of a graph for providing fault detection and diagnostic reports;

FIG. 4 is a diagram of a graph showing a sample view which may be a drill down from, as an illustrative example, a single air handling unit;

FIG. 5 is a diagram which shows a screen print of a heatmap timeline graph in an interactive demo;

FIG. 6 is a diagram of a dual hierarchy structure of heating, ventilation and air conditioning equipment and a building geometry;

FIGS. 7a and 7b are diagrams of sample views of a heating, ventilation and air conditioning equipment hierarchy and a building geometry hierarchy, respectively;

FIG. 8 is a diagram illustrating line plots superimposed over a heatmap timeline;

FIG. 9 is a diagram of an approach for visualizing time series information;

FIG. 10 is a diagram of a system for presenting data; and

FIG. 11 is a diagram of an approach for presenting time series data.

### DESCRIPTION

Commercial buildings, industrial plants, and other facilities are increasingly equipped with rich networks of sensors, allowing for collection and processing of large amounts of data. These data provide the opportunity for expert remote analysis through effective visualization techniques. For time-series data, analysts typically use line graphs, where data values are plotted over time. However, such plots are not necessarily effective for data of nominal measure type, and it may often be difficult for the analyst to visually aggregate ordinal data.

A technique for conveying time-series data, whether ordinal, nominal, interval, or ratio, may be a “heatmap timeline,” which is the subject of the present disclosure. Whereas line charts for time series data may use a vertical position to indicate the data value for each timestamp. The heatmap timeline may employ color hue, saturation, or value in order to indicate the data value.

Further precision may be provided in interactive computer environments through the use of “tooltips,” small pop-up windows that display the precise data value when a user points to an area of the heatmap timeline with an input device. The expected work flow may be that the analyst will first visually analyze the plot to identify areas of interest and then use the tooltip to discover the precise values.

Another aspect of the present timeline may be a coordination of the heatmap timeline and traditional line plots by timestamp. Multiple plots may be vertically stacked, or one or more line plots may be superimposed over a heatmap timeline plot. In this fashion, many variables may be displayed simultaneously and compared with one another.

These timelines may be viewed in static information graphics or alternatively integrated into interactive visualization environments.

To create an individual heatmap timeline plot, a data series may be required in which each data point is defined by a timestamp and value. The data value may be mapped to a color hue, saturation, shade, or value.

The heatmap timeline may have a fixed vertical height. Each data value may be represented by creating a rectangle where the height is equal to a fixed vertical height and the width is equal to the width of the overall chart, multiplied by the fractional part of the displayed timescale that the data value represents. In a case where a heatmap timeline is displayed on a computer screen, it may be common that the number of data values for display may exceed the number of screen pixels available to render the image. In this case, an aggregation strategy may be chosen to combine adjacent data values into a rectangle with a width of one or more pixels. Aggregation strategies may include, but are not limited to, the following items. For ordinal data, there may be a maximum, a minimum, a range, a sum, a weighted sum, a median, and an average. For nominal data, a function may be defined to choose a value judged most important or relevant.

Once both the rectangle width and color have been calculated, the rectangle may be rendered with its horizontal position located according to the associated timestamp's relative position along the entire displayed timeframe. This approach may be repeated for each data value or aggregation of data values to display virtually the entire selected timeframe.

As comparisons among different data views might often be essential to arriving at new insights, the present approach may provide for a coordinated display of heatmap timelines and trend data. A vertical line drawn through any stacked plots may intersect data values coordinated in time.

Strategies may be used to convey the value of the data to the analyst. One strategy may be to communicate the meaning of the hue, saturation, or value of color; a legend may be created where the distinct colors or color gradients are displayed, with labels indicating the data values associated with the distinct color, or the values at the extremities of the color gradients. Colors in a non-color layout may be represented by shade, symbols, patterns, and/or other grayscale or black and white techniques. A variety of symbols may be used, including but not limited to circles, squares, triangles, diamonds, stars, and so forth. Another strategy may be to allow for precise communication of the data value, and to allow for comparison of values among multiple data series; here, a tooltip may be used. The tooltip may be a small window that pops up when the user uses an input device to place a pointer on the heatmap timeline. Similar windows may appear on each heatmap timeline and line plot, so that the user can compare the precise values of many data types synchronized in time.

When data aggregation strategies have been used such that each rectangle in the heatmap timeline plot represents more than one data value, the tooltips may also be used to express the full timeframe represented by the rectangle, the aggregation strategy used, and/or the values of virtually all underlying data points aggregated into the chosen rectangle.

Often, analyzing data over differing time periods may reveal different insights. For example, data that have a daily cycle may be best viewed one week at a time to identify patterns, whereas data cycling hourly may be best be viewed one day at a time. So that an analyst may select an appropriate view of the data, the heatmap timeline is created based on a selected first and last timestamp. Even if the full data series extends beyond the selected beginning and ending timestamp, the heatmap timeline may be created based on the selected start and end time. When a new time interval is selected, aggregated performance numbers may be recomputed for the selected timeframe. In areas where data is not present or valid, the data may be conveyed using an additional color.

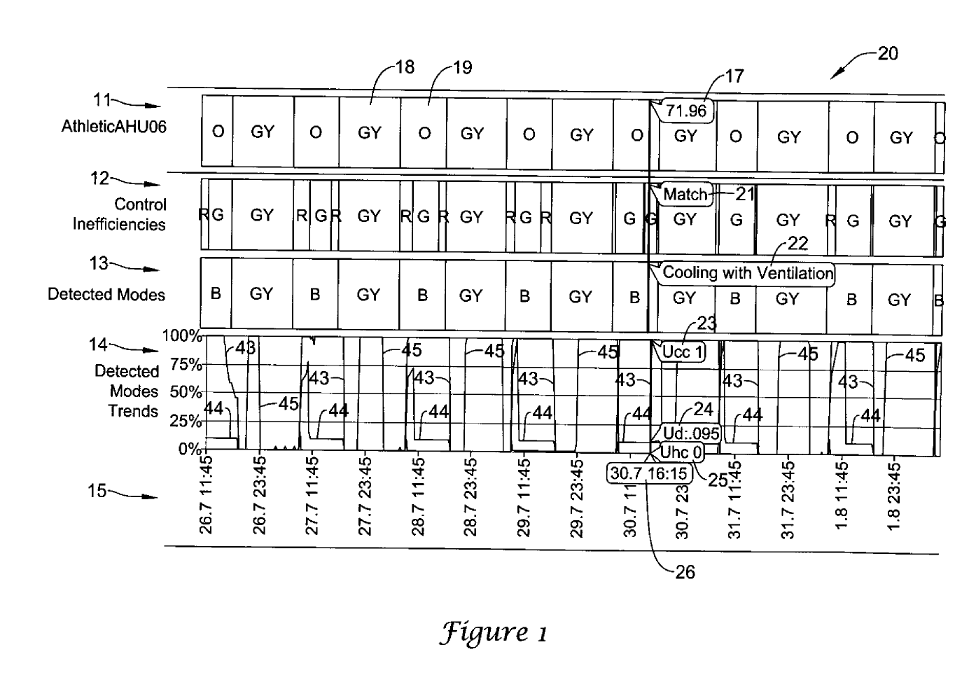

A heatmap timeline for time series data may be displayed as a graph 20 in FIG. 1. Row 11 shows values for equipment of interest such as, for example, an air handling unit (AHU) labelled in this case as “AthleticAHU06”. Row 12 shows values relative to control efficiencies. Row 13 shows values of detected modes. Row 14 shows values of detected mode trends. Row 15 is along an X-axis which may be used to display a synchronized timescale for the heatmap timeline and the line plots. Hue, saturation, or value of color may be used to indicate data values in rows 11-13 for each time step as indicated at example locations 18 and 19 in row 15. The colors orange, gray, red, green and blue may be indicated with the letters “O”, “GY”, “R”, “G” and “B”. For instance, locations 18 and 19 have colors grey and orange, respectively.

Coordinated tooltips such as tooltip 17 may be used to display more precise data values (e.g., 71.96) than otherwise indicated by the heatmap at a particular location such as in, for example, row 11. Information in row 12 for instance may indicate a condition such as a match as indicated by a tooltip 21. Data may be of a nominal type with each value mapped to a different color as indicated by a tooltip 22 which may reveal cooling and ventilation in row 13. Row 14 shows traditional line plots 43, 44 and 45 which may be synchronized with heatmap timeline plots in rows 11-13. Tooltips 23, 24 and 25 may identify the plots 43, 44 and 45 in row 14 as “Ucc: 1”, “Uc: 0.095” and Uhc: 0″, respectively. Plots 43, 44 and 45 may have their lines in color such as, for example, blue, red and purple, respectively. A tooltip 26 may indicate a specific time at a particular location in one or more of the rows 11-14 along an X-axis of row 15. The X-axis may be used to display a synchronized timescale for heatmap timeline plots and line plots.

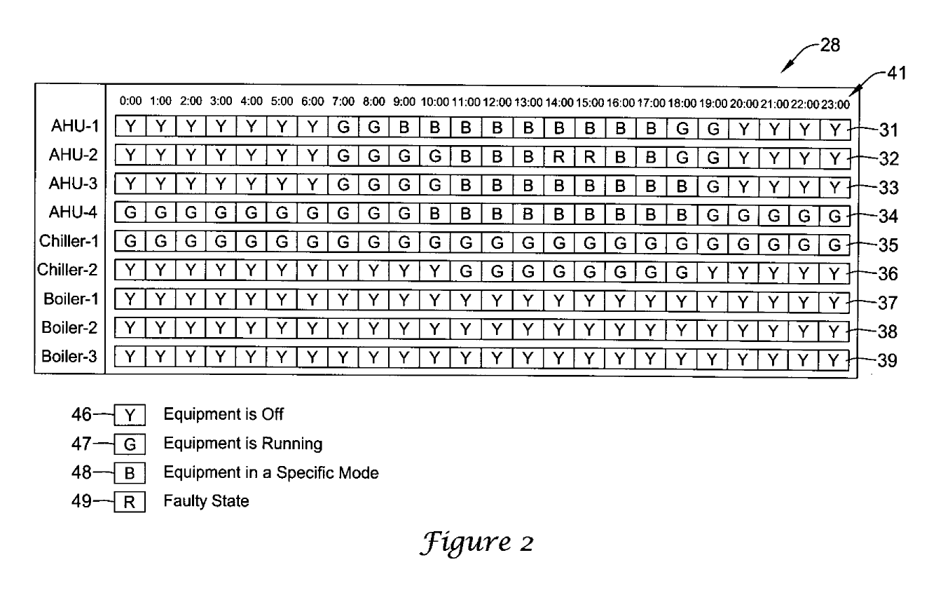

FIG. 2 is a diagram of a mosaic plot 28 revealing an operations summary. Mosaic plot 28 may be configured to show a specific number of hours of operational history for virtually all pieces of heating, ventilation and air conditioning (HVAC) equipment, as for example, AHU-1, AHU-2, AHU-3, AHU-4, chiller-1, chiller-2, boiler-1, boiler-2 and boiler-3 listed in a vertical axis for rows 31-39, respectively. A horizontal axis may indicate hourly time slots in a row 41 at the top of plot 28.

A color of each field may correspond to a specific state. A state may indicate an operating mode, a fault, and so forth. For an illustrative example, yellow may indicate that the equipment is off. Green may indicate that the equipment is running. Blue may indicate that the equipment is in a specific mode. Red may indicate a faulty state of the equipment, such as an AHU-2 in row 32 at times 14:00 and 15:00, and thus require investigation of the state of the AHU-2. In plot 28, yellow may be indicated by “Y”, green may be indicated by “G”, blue may be indicated by “B”, and red may be indicated by “R”. A legend in FIG. 2 shows the meaning of “Y”, “G”, “B” and “R” in blocks 46, 47, 48 and 49, respectively. Even though the X-axis 41 shows time increments of one hour, time discretization may be finer or greater than one hour.

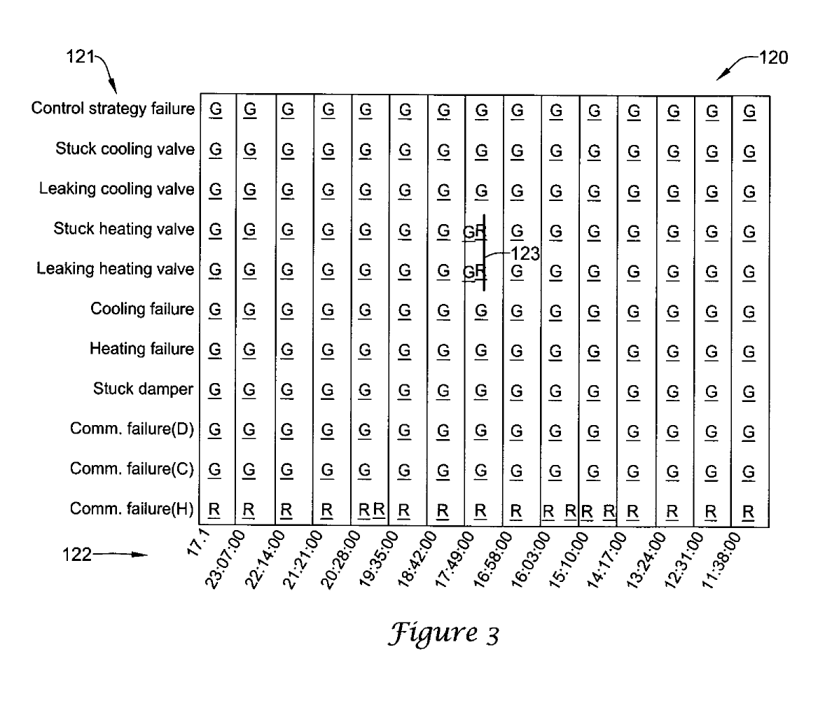

FIG. 3 is a graph 120 for providing fault detection and diagnostic (FDD) reports. A list of faults may be listed on a Y-axis 121. A time of occurrence may be noted in an X-axis 122. A condition of a pertinent component of a listed fault may be indicated in a corresponding row of graph 120. If there appears to be no problem detected relative to a possible fault, then a color in the respective row may be green (G). If there appears to be a problem, then a color in the respective row may be red (R). Other colors may indicate situations between no problem and a problem. The choice of colors and corresponding meanings may be selected at the discretion of a designer or user of the graph or display. Listed examples of possible faults may incorporate control strategy failure, stuck cooling valve, leaking cooling valve, stuck heating valve, leaking heating valve, cooling failure, stuck damper, comm. failure (D), comm. failure (C) and comm. failure (H). There may be other examples.

Comm. failure (H) may appear to have a problem with its row being mostly red over nearly the entire time represented by X-axis 122. The other components appear have corresponding rows of green over virtually all of the time represented by X-axis 122. An exception may be indication by a short term of red as indicated by symbol 123 relative to a stuck heating valve and a leaking heating valve.

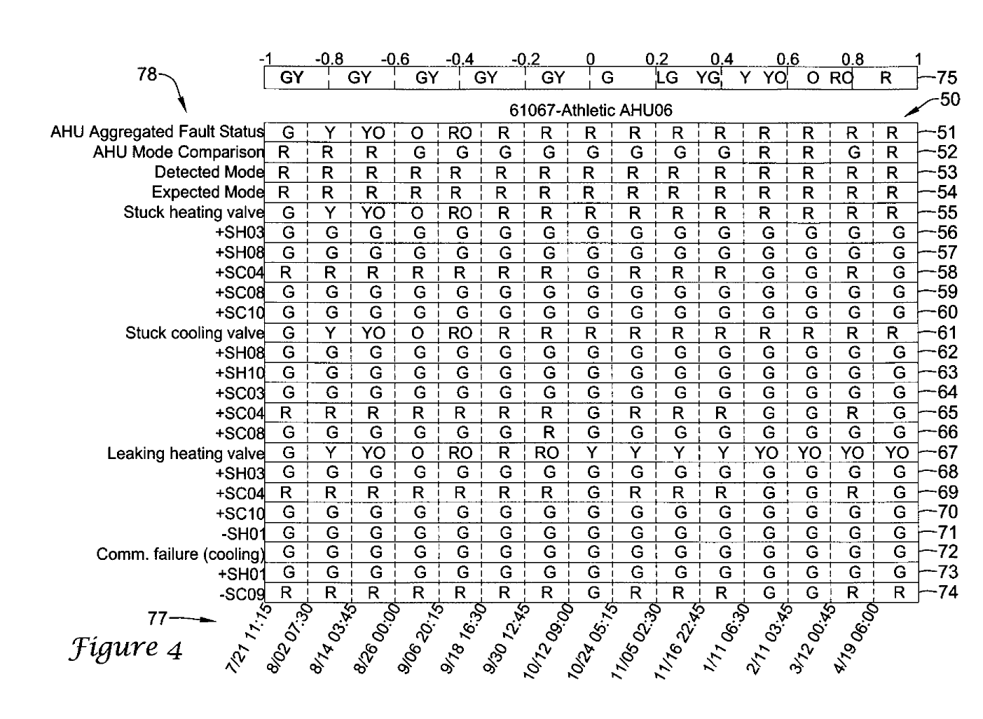

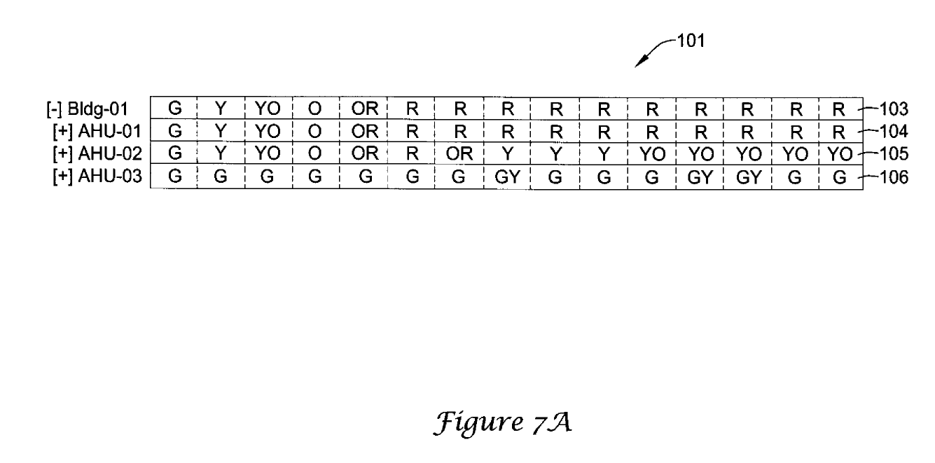

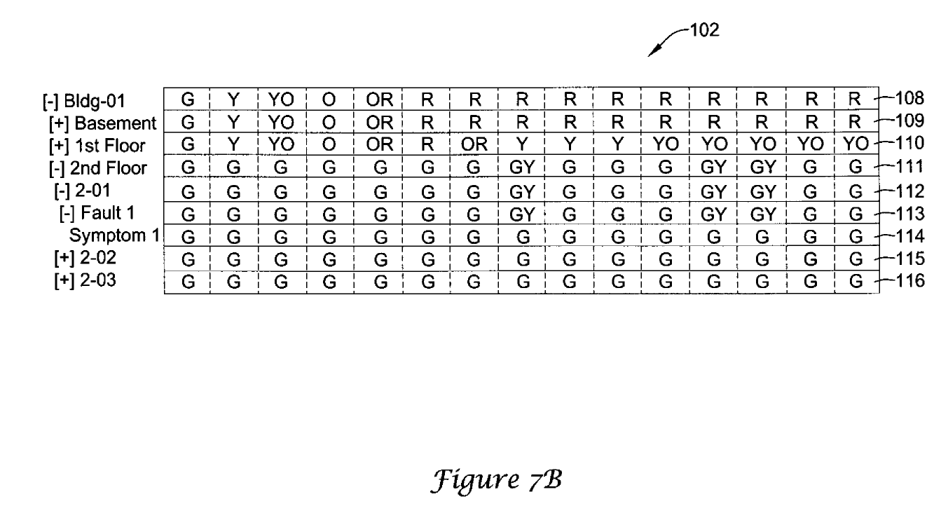

FIG. 4 is a diagram of a graph 50 showing a sample view which may be a drill down from a single AHU, like one indicated in FIG. 7a. A drill down may be interactive and from a hierarchical view like that in FIG. 7a. The graph in FIG. 4 may represent information with color. A color bar 75 above the graph may be used to interpret the information in the graph. Bar 75 may have a scale which ranges from −1.0 to +1.0. The scale may be represented by a variation of color. The choice of color may be as desired. In the present example, since graph 50 of FIG. 4 is not in color in this patent application, the colors may be described with designation and description. Colors may also or instead be represented by shade or pattern. The color from −1.0 to 0.0 may be grey as indicated by “GY”. The color from 0.0 to +0.2 may vary from green (“G”) to light green (“LG”). The color from +0.2 to +0.4 may vary light green through yellow green (“YG”). The color from +0.4 to +0.6 may vary from yellow (“Y”) through yellow orange (“YO”). The color from +0.6 to +0.8 may vary from orange (“O”) to red orange (“RO”). The color from +0.8 to +1.0 may vary from red orange to red (“R”). Grey represents a neutral condition. Green represents a good condition. Red represents a failed condition. The colors between green and red represent conditions (e.g., fair or poor) between the good and failed ones.

In the graph 50, there may be, for example, 24 rows of vertical lines or stripes of various colors indicating conditions at certain times as noted with an X-axis 77. The X-axis may have labels indicating times, for example, from “Jul21 11:15” to “Apr19 06:00”, with in-between times listed on the axis. The time increments may be determined in accordance with needs or desires of the user or users of the graph. The rows may provide conditions of various kinds of items, as listed along a Y-axis 78 at a left portion of graph 50.

A top row 51 is, for instance, labeled “AHU Aggregated Fault Status”, which may indicate a top level maximum aggregated fault value. Row 53 may indicate a detected mode and row 54 may indicated an expected mode. Row 52 may indicate an AHU mode comparison. For the same time slot, if the detected and expect modes, in row 53 and 54 respectively, are significantly different in condition, according their color lines or stripes, then a line or stripe for that time slot for the AHU mode comparison in row 52 may indicate a poor or faulty condition, despite whether the colors in the stripes or lines of both rows represent a faulty or good condition, or a condition in between the faulty and good conditions. For the same time slot, if the detected and expected modes, in rows 53 and 54 respectively, are significantly the same in condition, according their color lines or stripes, then a line or stripe for that time slot for the AHU mode comparison in row 52 may indicate a good condition or good comparison, despite whether the colors in the stripes or lines of both rows represent a faulty or good condition, or a condition between the faulty and good conditions. The AHU mode comparison in row 52 may be regarded as a control inefficiency monitor.

Rows 55, 61, 67 and 72 may represent illustrative examples which include a high relevance fault such as a stuck heating valve, a stuck cooling valve, a leaking heating valve and a comm. failure (cooling). Relative to the stuck heating valve of row 55, the contributing symptoms may be +SH03, +SH08, +SC04, +SC08 and +SC10 of rows 56, 57, 58, 59 and 60, respectively. Relative to the stuck cooling valve of row 61, the contributing symptoms may be +SH08, +SH10, +SC03, +SC04 and +SC08 of rows 62, 63, 64, 65 and 66, respectively. Relative to the leaking heating valve of row 67, the contributing symptoms may be +SH03, +SH04 and +SC10 of rows 68, 69 and 70, respectively. A canceling symptom relative to the leaking heating valve may be −SH01 of row 71. Relative to the comm. failure (cooling) of row 72, a contributing symptom may be +SH01 of row 73. A canceling symptom relative to the comm. failure (cooling) may be −SH09 of row 74.

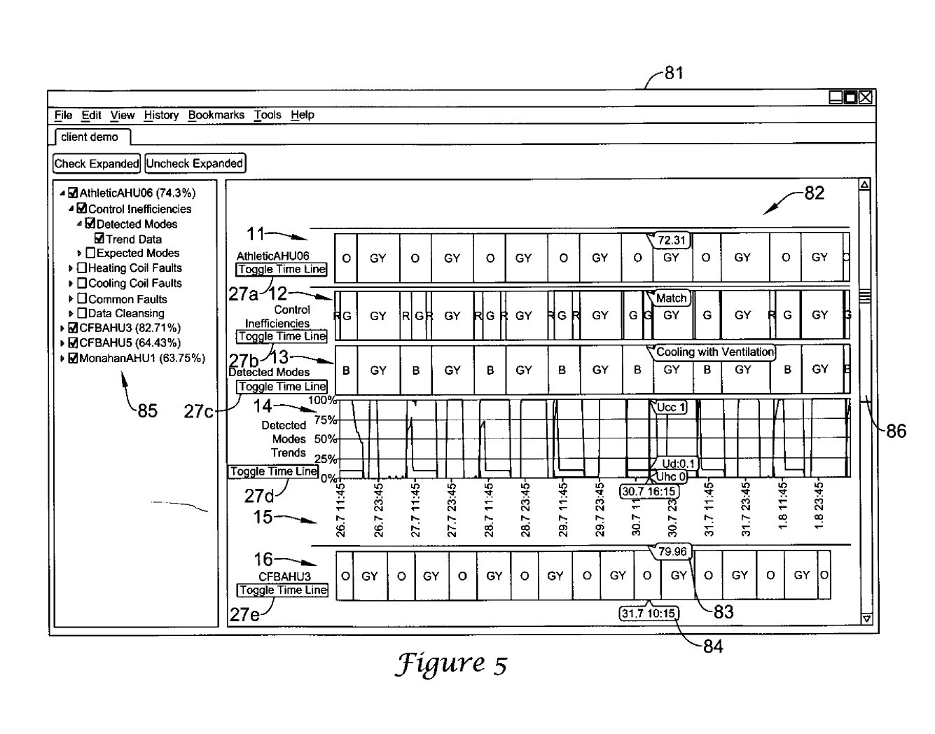

FIG. 5 is a diagram of a screen print 81 showing heatmap timelines graph 82 in an interactive demo. The five top portions or rows are shown in a graph 20 of FIG. 1 and described in accompanying text. In summary, Row 11 shows values for an air handling unit labelled in this case as “AthleticAHU06”. Row 12 shows values relative to control efficiencies. Row 13 shows values of detected modes. Row 14 shows values of detected mode trends. Row 15 is an X-axis which may be used to display a synchronized timescale for the heatmap timeline and the line plots. Color hue, saturation, or value may be used to indicate data values in rows 11-13 for each time step as indicated in row 15. In grey scale or black and white line diagrams, shade or patterns may be used to represent various colors or values. Further details relative to rows may be provided in the description about FIG. 1.

Rows 11-14 may be referred to heatmap timelines in FIG. 5. Items 27a, 27b, 27c, 27d and 27e may be referred to the buttons (labelled as “Toggle Time Line” in this particular case) that may be used for activating and deactivating the display of the corresponding timeline. For example, after pressing the button 27d, the row 15 may be hidden (deactivated). By pressing the button 27d again, the row 15 may reappear (become activated) as shown in FIG. 5. A row 16 shows values for an air handling unit labelled as “CFBAHU3” along a toggle time line. An X-axis along the bottom of row 16 indicates the time for the indicated values. The values may be indicated by colors like those in row 11. Orange may be identified with an “O” and grey with “GY”, as in FIG. 1. A tooltip 83 may provide a value, such as for instance, “79.96”, at a particular place on row 16. A particular time, for instance, “31.7.2009 10.15”, at that value may be indicated in a label 84.

An index or navigation tree 85 at the left side of screen print 81 shows “AthleticAHU06(74.3%), “Control Inefficiencies”, Detected Modes” and “Trend Data”, being selected with checkmarks, may be revealed in graph 82. Also selected with checkmarks, there may be items “CFBAHU3(82.71%)”, “CFBAHU5(64.43%)” and “MonahanAHU1(63.75%)”. Row 16 may show values for CFBAHU3 at the bottom of screen print 81. One may with a bar 86 scroll down to rows of values for CFBAHU5 and MonahanAHU1. Other items which might be selected in tree 85 may incorporate heating coil faults, cooling coil faults, common faults and data cleaning as examples.

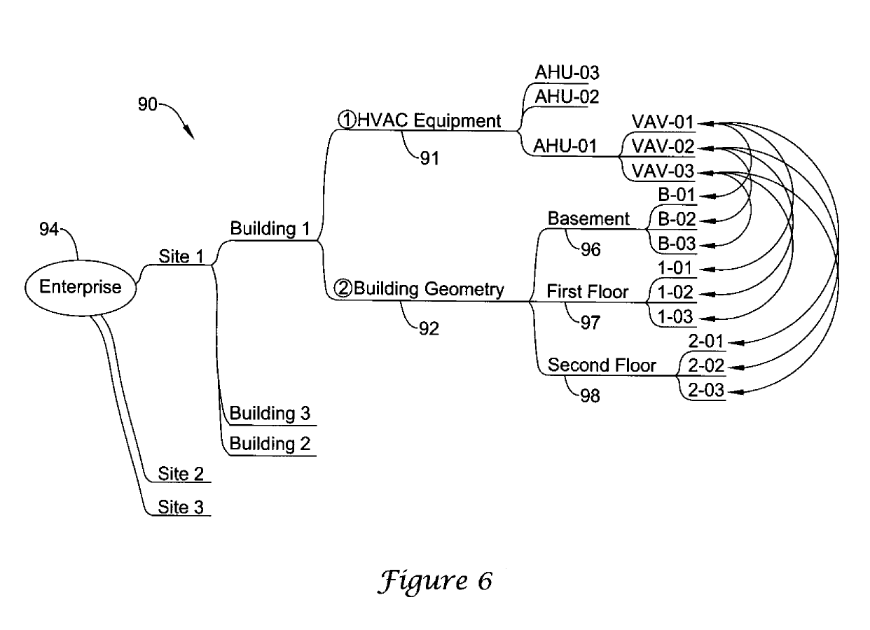

FIG. 6 is a diagram of a dual hierarchy structure 90 of HVAC equipment 91 and building geometry 92. An enterprise 94 may have connections to a site 1, site 2 and site 3. Enterprise 94 may have connections to more or less sites. Site 1 may be looked at as an example which may have connections to a building 1, a building 2 and a building 3. Site 1 may have connections to more or less buildings. The hierarchy structure 90 of building 1 may be noted as an instance. Equipment 91 may incorporate an AHU-01, AHU-02 and AHU-03, and potentially other types of equipment as well. Equipment 91 may incorporate more or less AHUs. AHU-01 may have, for example, a VAV-01 (variable air volume device), a VAV-02 and a VAV-03. An AHU may have more or less VAVs.

Building geometry 92 of building 1 may incorporate a basement 96, a first floor 97 and a second floor 98. The geometry may incorporate more or less floors, or other types of areas defined in different terms. The VAV-01 may serve, for example, zones B-01, 1-01 and 2-01 of the basement 96, first floor 97 and second floor 98, respectively. The VAV-02 may serve, for example, zones B-02, 1-02 and 2-03 of the basement 96, first floor 97 and second floor 98, respectively. The VAV-03 may serve, for example, zones B-03, 1-03 and 2-03 of the basement 96, first floor 97 and second floor 98, respectively. There may be other hierarchy structure configurations for HVAC equipment and building geometry that may be implemented. A configuration may be designed in response to desired extensions for building optimization analytics, viewing and analysis of conditions, and results of HVAC equipment 91 and building geometry 92. There may be links between the VAVs and served zones that can tie faults and other diagnostics from equipment to zones. There may be a drill-down from an overall perspective to different analysis levels.

FIGS. 7a and 7b are diagrams of sample hierarchical views 101 and 102, respectively. A view may be indexed by an HVAC equipment 91 hierarchy or a building geometry 92 hierarchy, as represented by the sample hierarchical views 101 and 102, respectively. Both views may indicate an aggregated fault status. The rows 103-106 and 108-116 may be in the same format as the rows of information with similar coding and time scale as view 50 of FIG. 4.

In views 101 and 102, there may be an interactive drill-down by expanding [+] markers in the index which may be linked to an index or navigation tree. For instance in graph 101, [−]Bldg-01 may be [+]Bldg-01 at row 103 without rows 104, 105 and 106. If [+]Bldg-01 is clicked on (i.e., the [+] marker being expanded), then rows 104, 105 and 106 may appear representing information (e.g., aggregated fault status) about AHUs in Building 01. Particularly, rows 104, 105 and 106 may represent information about AHU-01, AHU-02 and AHU-03, respectively. The ledgers in the hierarchical view or graph may represent the AHUs with the notation [+]AHU-01, [+]AHU-02 and [+]AHU-03, respectively, at rows 104, 105 and 106. Interactive drill-down may be achieved by clicking on or expanding a [+] marker of one of the AHUs. For example, if [+]AHU-01 were instead [+]AHU06 and clicked on, one may get a drill down from this AHU in view 101 under a [−]AHU06 which would look like chart, graph or view 50 of AHU aggregated fault status at row 51 along with rows 51-74, as shown in FIG. 4.

FIG. 7b is a diagram of a hierarchical view 102 of the building 1 indexed by geometry 92. Row 108 may indicate an aggregated fault status of building 1. Row 108 may be labeled as [−]Bldg-01 which has a drill down from an expansion of a [+] marker in a previous label [+]Bldg-01 where rows 109-116 were absent. A drill down from [−]Bldg-01 may result in rows 109, 110 and 111 for [+]Basement, [+]1st Floor and [+]2nd Floor. A drill down from [−]2nd Floor may result in rows 112, 115 and 116 for zones [+]2-01, [+]2-02 and [+]2-03, respectively. A drill down from, for example, [−]2-01 may result in a [+]Fault 1 with a row 113. A click on [+]Fault 1 may result in drill down from [−]Fault 1 at row 113 having a symptom 1 at row 114.

Drill down may be taken to be an arbitrary depth (e.g., based on a number of hierarchical levels in the actual system). However, something that is hierarchical may not necessarily need to be explained as multiple layers of the hierarchy.

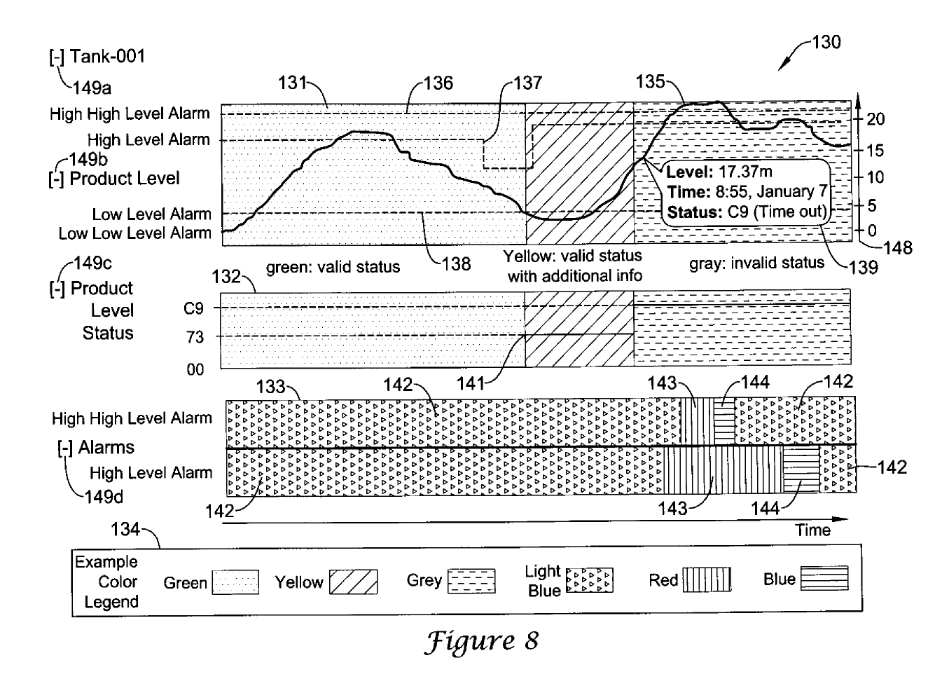

In FIG. 8, charts 131 and 132 are an illustration of line plots superimposed over a heatmap timeline. In this particular example, a measured variable (i.e., product level in meters) is shown by line plot 135, while another variable (i.e., product level status) is indicated by background color, green, yellow and grey of heatmap timeline. Legend 134 indicates a coloring coding of the background in charts. Multiple line plots may be superimposed, such as, for example, a high level alarm threshold, high high level alarm threshold and a low level alarm threshold, as shown by dashed lines 136, 137 and 138, respectively. There may be a low low level alarm threshold not show by a line. A product temperature line plot, as well as other plots, may be superimposed on the heatmap timeline. A tooltip 139 may be used to display more precise data values (e.g., a level 17.37, time 8:55, January 7 and status C9 of time out) at a particular place of a heatmap time such as chart 131. A magnitude or value indicating, or numerical axis 148 may be used to display selected values (e.g., 0, 5, 10, 15, and 20) related to the variables shown by the line plots (in this particular example by the plots 135, 136, 137, and 138). Chart 132 may identify product level status with line 141 of “00”, “73” and “C9”.

In chart 133 of FIG. 8, the heatmap timeline may be used to visualize alarm-related data, and use a suitable color coding, such as light blue color in portion 142 (alarm is enabled), red color in portion 143 (alarm is active), blue color in portion 144 (alarm is acknowledged), for example, the high high level and the high level alarms. Alternatively, other visualization options may be used for charts 131-133, such as different colors, use of symbols, patterns, shades, and so forth, as noted herein.

Similarly as in FIGS. 7a and 7b, in view 130 of FIG. 8, there may be an interactive drill-down by expanding [+] markers in the index which may be linked to an index or navigation tree. For instance in graph 130, [−]Tank-001 may be [+]Tank-001 at item 149a without items 149b, 149c and 149d. If [+]Tank-001 is clicked on (i.e., the [+] marker being expanded), then items 149b, 149c, 149d may appear representing information about Tank-001. Particularly, items 149b, 149c and 149d may represent information about product level, product level status and alarms, respectively, related to Tank-001.

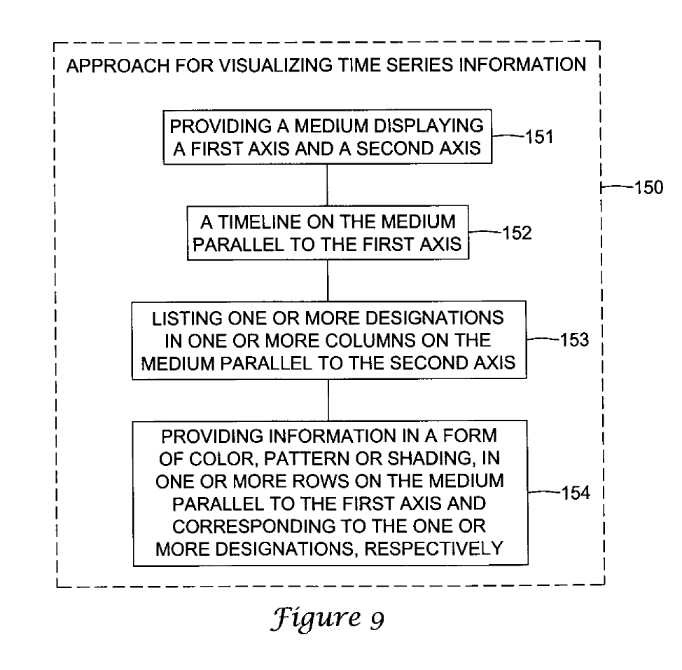

To recap, an approach 150, in a diagram of FIG. 9, for visualizing time series information may incorporate providing 151 a medium displaying a first axis and a second axis, providing 152 a timeline on the medium parallel to the first axis, listing 153 one or more designations in one or more columns on the medium parallel to the second axis, and providing 154 information in a row on the medium parallel to the first axis corresponding to each designation of the one or more designations. The information may have one or more values coded in a hue, saturation or value of color, or pattern and/or shading. Each row of information may be in a form of a graphical representation. The graphical representation may have a format of a heatmap. An increment of information may have a time indicated by a position of the increment relative to the timeline. The first and second axes may be situated relative to each other at an angle greater than zero. If a number of information values exceeds a number of pixels of a display available to render an image of the information values on a display, then an aggregation of the information values may combine the information values into a symbol having a width of one or more pixels.

Approach 150 may further incorporate providing a line plot that represents values of the information corresponding to the one or more designations. The line plot may be synchronized with the values of the information in accordance with the timeline. The line plot may be superimposed over a respective row of information. There may be an axis for determining values from the line plot. The approach may also incorporate obtaining a precise value of the information at a particular place relative to the timeline. The precise value of the information may be provided by a tooltip having a pop-up window that displays the precise value of the information.

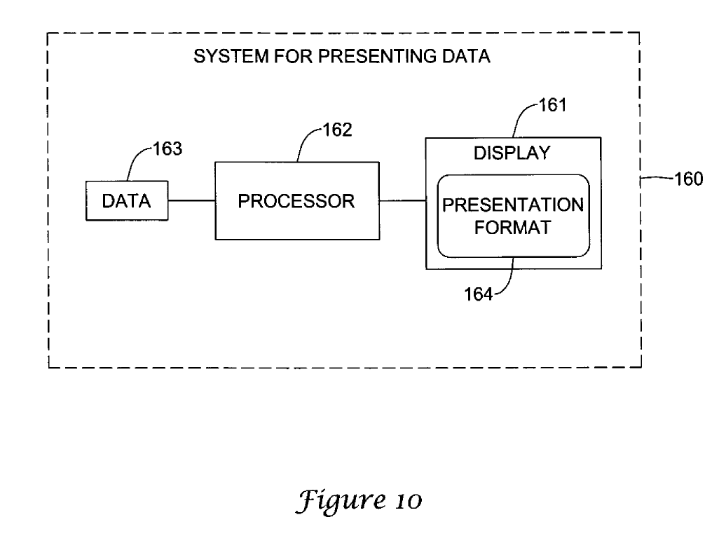

A system 160, in a diagram of FIG. 10, for presenting data, may incorporate a display 161 and a processor 162 connected to the display. The processor 162 may convert data values 163 into a format 164 presentable on display 161. The format 164 may be that of a heatmap timeline. The heatmap timeline may incorporate a timeline and a listing of one or more designations having data values. The data values may be represented by symbols along the timeline. The symbols may have hue, saturation and/or value of color, or pattern and/or shading that represent data values. The symbols may have a graphical magnitude without indication of data values. The graphical magnitude may have a direction greater than zero degrees relative to a direction of the timeline.

The symbols may be arranged in a row proximate to a designation of the listing of one or more designations having the data values represented by the symbols. The symbols may incorporate rectangles, as examples, situated proximate to one another in a row. Each rectangle may have a start and end time with a particular data value represented by the hue, saturation and/or value of color, or pattern and/or shading within a respective rectangle corresponding to the particular data value. The start and end times may be indicated by ends of a rectangle relative to the timeline.

System 160 may also have one or more line plots of data values of the one or more designations having the data values. The line plots may be time synchronized with the start and end times of the rectangles.

In system 160, a symbol may represent an aggregation of a plurality of data values. Aggregation strategies may, for instance, include, but not be limited to, items noted herein. For ordinal data, there may be a maximum, a minimum, a range, a sum, a weighted sum, a median, and an average. For nominal data, a function may be defined to choose a value judged most important or relevant.

System 160 may have one or more tooltips which may be placed on a symbol to obtain a particular data value at a certain time on the timeline.

The data values of one or more designations may indicate an aggregated status for various times along the timeline. Some of the one or more designations have expansion markers which may be activated for a drill-down of a hierarchy of each of the some of the one or more designations. The drill down may result in one or more components of the hierarchy. The one or more components may have data values represented by an addition of one or more heatmap timelines. The drill down may be taken to be to an arbitrary depth (e.g., based on a number of hierarchical levels in the actual system). It may be noted that something that is hierarchical may not necessarily have to be explained as multiple levels or layers of the hierarchy.

In system 160, format 164 may incorporate a mosaic. The mosaic may have a timeline and one or more rows of symbols or items, such as blocks used merely as illustrative examples of the symbols or items, parallel to the timeline. Each of the one or more rows of the blocks may be associated with one or more pieces of equipment, or one or more components of equipment. Each block of the one or more rows of blocks may also be associated with a time increment. Each block may represent a data value with a hue, saturation and/or value of a color, or pattern and/or shading. The data value may be a status or property of one or more pieces of equipment or one or more components of the one or more pieces of equipment.

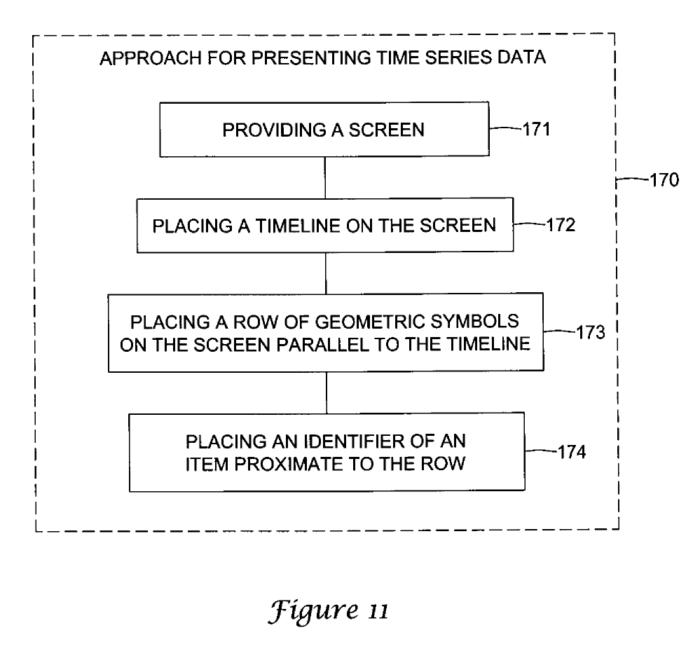

An approach 170, in a diagram of FIG. 11, for presenting time series data, may incorporate providing 171 a screen, placing 172 a timeline on the screen, placing 173 a row of geometric symbols, representing data with graphics other than linear, e.g., duration, or spatial magnitude, on the screen parallel to the timeline, and placing 174 an identifier of an item proximate to the row. The geometric symbols may represent data of the item. The geometric symbols may be aligned with the timeline to indicate a time of data represented by a respective geometric symbol. The geometric symbols may represent data according to colors or other graphical designations. The timeline, the row of geometric symbols, and the geometric symbols may be aligned with the timeline and represent data according to color are regarded as a heatmap timeline. Approach 170 may further incorporate additional rows of geometric symbols representing data of items.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A method for visualizing time series information, comprising:
providing a medium displaying a first axis and a second axis;
providing a timeline on the medium parallel to the first axis;
listing one or more designations in one or more columns on the medium parallel to the second axis; and
providing information in one or more rows on the medium parallel to the first axis corresponding to each designation, respectively, of the one or more designations; and
wherein:
the information has one or more values coded in a hue, saturation or value of color, and/or pattern and/or shading;
each row of information is in a form of a graphical representation;
an increment of information has a time indicated by a position of the increment relative to the timeline; and
the first and second axes are situated relative to each other at an angle greater than zero.

2. The method of claim 1, wherein if a number of information values exceeds a number of pixels of a display available to render an image of the information values on a display, then an aggregation of the information values combines the information values into a symbol having a width of one or more pixels.

3. The method of claim 1, further comprising:
providing one or more line plots that represent values of the information corresponding to the one or more designations; and
wherein the one or more line plots are synchronized with the values of the information in accordance with the timeline.

4. The method of claim 3, further comprising:
obtaining a precise value of the information at a particular place relative to the timeline; and
wherein the precise value of the information can be provided by one or more tooltips having a pop-up window that displays the precise value of the information in the form of a graphical representation and/or of the one or more line plots.

5. The method of claim 3, wherein the one or more line plots are superimposed over a respective row of information.

6. The method of claim 5, further comprising one or more numerical axes for indicating values related to one or more line plots.

7. The method of claim 1, wherein the graphical representation comprises a format of a heatmap.

8. A system for presenting data, comprising:
a display; and
a processor connected to the display; and
wherein:
the processor converts data values into a format presentable on the display; and
the format comprises a heatmap timeline.

9. The system of claim 8, wherein the heatmap timeline comprises:
a timeline; and
a listing of one or more designations having data values; and
wherein:
the data values are represented by symbols along the timeline; and
the symbols comprise hue, saturation and/or value of color, and/or pattern and/or shading.

10. The system of claim 9, wherein:
the symbols comprise a graphical magnitude without indication of data values; and
the graphical magnitude has a direction greater than zero degrees relative to a direction of the timeline.

11. The system of claim 10, wherein the symbols are arranged in a row proximate to a designation of the listing of one or more designations having the data values represented by the symbols.

12. The system of claim 9, wherein:
the symbols comprise rectangles situated proximate to one another in a row and each rectangle has a start and end time of a particular data value represented by the hue, saturation and/or value of color, and/or pattern and/or shading within a respective rectangle corresponding to the particular data value; and
start and end times are indicated by ends of a rectangle relative to the timeline.

13. The system of claim 12, further comprising:
one or more line plots of data values of the one or more designations having the data values; and
wherein the one or more line plots are time synchronized with the start and end times of the rectangles.

14. The system of claim 9, wherein:
a symbol represents an aggregation of a plurality of data values;
the aggregation comprises for ordinal data a maximum, a minimum, a range, a sum, a weighted sum, a median, an average, and any other mathematical operation of the plurality of data values; and
the aggregation for nominal data comprises a function defined to choose a value judged most important or relevant among the plurality of data values.

15. The system of claim 14, further comprising one or more tooltips which may be placed on a symbol to obtain a particular data value at a certain time on the timeline.

16. The system of claim 9, wherein:
the data values of one or more designations indicate an aggregated status for various times along the timeline;
some of the one or more designations have expansion markers which may be activated for a drill-down of a hierarchy of each of the some of the one or more designations;
the drill down results in attaining a particular depth of the hierarchy; and
the particular depth has one or more data values that are represented by adding one or more heatmap timelines.

17. The system of claim 8, wherein:
the heatmap timeline comprises:
a timeline; and
one or more rows of symbols parallel to the timeline; and
wherein:
each of one or more rows of symbols is associated with one or more pieces of equipment, or one or more components of equipment;
each symbol of the one or more rows of symbols is associated with a time increment;
each symbol represents a data value with a hue, saturation and/or value of a color, and/or pattern and/or shading; and
a data value is a status or property of one or more pieces of equipment or one or more components of one or more pieces of equipment.

18. The system of claim 8, wherein:
the heatmap timeline comprises a mosaic; and
the mosaic comprises:
a timeline; and
one or more rows of symbols parallel to the timeline; and
wherein:
each of one or more rows of symbols is associated with one or more pieces of equipment, or one or more components of equipment;
each symbol of the one or more rows of symbols is associated with a time increment;
each symbol represents a data value with a hue, saturation and/or value of a color, and/or pattern and/or shading; and
a data value is a status or property of one or more pieces of equipment or one or more components of one or more pieces of equipment.

19. An approach for presenting time series data, comprising:
providing a screen;
placing a timeline on the screen;
placing a row of geometric symbols on the screen parallel to the timeline; and
placing an identifier of an item proximate to the row; and
wherein:
the geometric symbols represent data of the item; and
the geometric symbols are aligned with the timeline to indicate a time of data represented by a respective geometric symbol.

20. The approach of claim 19, wherein the timeline, the row of geometric symbols, and the geometric symbols aligned with the timeline and representing data according to color are regarded as a heatmap timeline.
